(19) United States
(12) Patent Application Publication
(10) Pub. No.: US 2006/0252015 A1
(43) Pub. Date: Nov. 9, 2006

(54) Semi-custom method of educating and developing individuals

(76) Inventor: Roque R. Figueroa, Milford, MA (US)

Correspondence Address: LAW OFFICE OF BRETT N. DORNY, 386 WEST MAIN STREET, SUITE 12A, NORTHBOROUGH, MA, 01532, US

(21) Appl. No.: 11/370,256

(22) Filed: Mar. 6, 2006

Related U.S. Application Data
(60) Provisional application No. 60/658,695, filed on Mar. 4, 2005.

(51) Int. Cl. G09B 19/00

(52) U.S. Cl. 434/236

(57) ABSTRACT

A system is disclosed for providing semi-customized educational and development programs for individuals. A caregiver submits information to the system relating to an individual's educational and/or development level, goals, special needs, and preferences. The system uses the submitted information to create a customized educational and/or development program. The system further creates training segments to in accordance with the customized program.

### CROSS-REFERENCE TO RELATED APPLICATIONS

This application claims priority to Provisional U.S. Patent Application No. 60/658,695, file Mar. 4, 2005.

### BACKGROUND OF THE INVENTION

1. Field of the Invention

The present invention relates generally to the education and development of individuals, and more specifically to a semi-custom educational and developmental mail order method, where said method of semi-custom education and development incorporates the Individual's, (including but not limited to, children, the elderly, the sick or the lonely (hereinafter “Individuals”)), needs and the caregiver's, (including but not limited to primary (such as parents or guardians or the like), secondary (such as relatives) and support caregiver's (such as friends) (hereinafter “Caregiver”)), specific goals into said method of education and development.

2. Discussion of Related Art

Education and development programs for Individuals are widely used and known throughout the world. Primarily, school aged children, typically ages 4 through 18, pre school aged children, typically newborn to 4 years old, and adults, are educated and developed in schools, through a formal education in a public or private school, or through daycare, home schooling, tutoring, mail order, internet or the like. Caregivers of Individuals may desire additional or secondary education and development. Secondary education and development programs are widely used and known throughout the world. Individuals may attend after Primary school programs, such as academic tutoring or organized sports, may be put in daycare, or receive additional education and development through home schooling, home tutoring, mail order, internet or the like. Said Primary and Secondary programs are generally developed to fit the average student and are not generally tailored the specific educational or developmental needs of the Individual and the specific educational or developmental goals of the Caregiver. An Individual, however, may receive a tailored educational and developmental program, usually through a nanny or employee of the Caregiver, at significant cost, which is generally not affordable to the average family. A Caregiver of an average family, however, may desire a tailored program in addition to, or in place of, the aforementioned Primary and Secondary programs, that is affordable.

Furthermore, while affordable mail order programs have been developed to make Individuals feel special and cared for, none have been created to specifically educate and develop an Individual according to the Individual's specific educational and developmental needs in conjunction with the Caregiver's goals for the education and development of the Individual.

There is therefore a need in the art for a an affordable method of education and development where said method tailors an Individual's education and development to the Individual's educational and developmental needs in conjunction with the Caregiver's educational and developmental goals that is delivered to the Individual via a mail service (including but not limited to the United States Postal Service, E-Mail, and other means known to one of ordinary skill in the art (hereinafter “Mail Service”)).

It is therefore a principal object of the present invention to provide a semi-custom method of educating and developing Individuals according to the Individual's educational and developmental needs and the Caregiver's educational and developmental goals.

A further object of the present invention is to provide a semi-custom method of educating and developing Individuals according to the Individual's educational and developmental needs and the Caregiver's educational and developmental goals that is delivered to the Individual via a Mail Service.

A further object of the present invention is to provide a semi-custom method of educating and developing Individuals according to the Individual's educational and developmental needs and the Caregiver's educational and developmental goals that fosters Individual/Caregiver interaction.

A further object of the present invention is to provide a semi-custom method of educating and developing Individuals according to the Individual's educational and developmental needs and the Caregiver's educational and developmental goals that promotes the building an Individual's perspective and self esteem.

A further object of the present invention is to provide a semi-custom method of educating and developing Individuals according to the Individual's educational and developmental needs and the Caregiver's educational and developmental goals that is affordable.

A further object of the present invention is to provide a semi-custom method of educating and developing Individuals according to the Individual's educational and developmental needs and the Caregiver's educational and developmental goals that can be implemented in a number of types of systems, from simple manual or electronic devices to computerized systems.

With these and other objects in view, as will be apparent to those skilled in the art, the invention resides in the combination of steps set forth in the specification and covered by the claims appended hereto.

### SUMMARY OF THE INVENTION

A novel approach to an Individual's education and development has now been developed, thus providing Caregiver's with a semi-custom method of educating and developing an Individual. The present invention uses the Lil Post™ system to assist the Caregiver in designing a semi-custom, affordable, educational and developmental program. The present invention also uses the Lil Post™ system to assist the Caregiver in redesigning said program once it is implemented. By practicing the disclosed invention, the Caregiver and Individual will now enjoy a method of education and development that allows the Caregiver to customize the Individual's educational and developmental program to the Individual's needs and the Caregiver's goals. The advantages of using the present invention include: semi-custom educational and developmental program at an affordable cost, future alterability of the designed program and the availability of customer service assistance in the design of said program.

These and other objects, as will be apparent to those skilled in the art, along with advantages and features of the invention disclosed herein, will be made more apparent from the description, drawings and claims that follow.

### BRIEF DESCRIPTION OF THE DRAWINGS

The foregoing and other objects, features and advantages of the present invention, as well as the invention itself, will be more fully understood from the following description of preferred embodiments, when read together with the accompanying drawings, in which:

FIG. 1 is a flow diagram depicting the principal steps in an embodiment of the present invention from the User/Caregiver's perspective;

FIG. 2 is a flow diagram depicting the principal steps in an embodiment of the present invention from the System/Lil Post's™ perspective;

FIG. 3 is an embodiment of the front side of an educational and developmental card; and

FIG. 4 is an embodiment of the backside of an educational and developmental card.

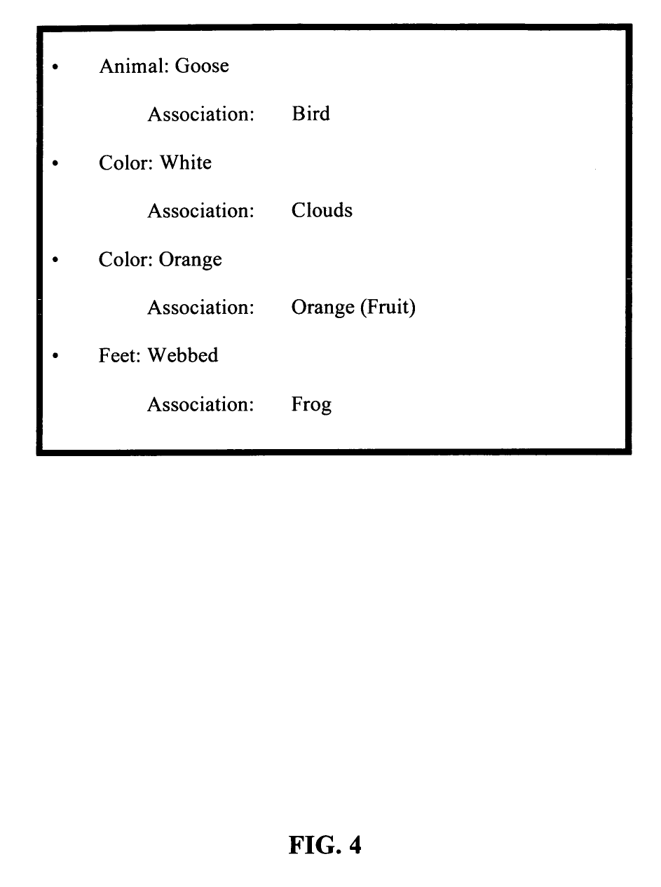

### DETAILED DESCRIPTION

### REFERENCE NUMBERS IN FIGURES

10. Lil Post™ System User/Caregiver Perspective

10a. Lil Post™ Process Initial Step

10b. Order Step

10c. Payment and Delivery Step

10d. Introductory Questionnaire Step

10e. Caregiver Goals Step

10f. Special Needs Step

10g. Likes and Dislikes Step

10h. Order Submission Step

10i. Learn More Step

10j. Redesign Program or Order Another Step

10k. Exit Lil Post™ System

10l. Change Goals, Needs, Likes/Dislikes Step

10m. Restart System Step

12. Lil Post™ System Perspective

12a. Lil Post™ Wait for Input Step

12b. Lil Post™ Receive and Process Order and Payment Information Step

12c. Lil Post™ Questionnaire Step

12d. Lil Post™ Goals, Special Needs, Likes and Dislikes Step

12e. Lil Post™ Program Preparation Step

12f. Lil Post™ Delivery Step

12g. Lil Post™ Change Step

12h. Lil Post™ Information Step

12i. Lil Post™ Exit Step

14. Educational and Developmental Tool Front

16. Educational and Developmental Tool Back

In the broadest aspects, the present invention provides the skilled artisan with the analytical tools and technical know-how sufficient to make and use the disclosed invention. The present invention provides the consumer with a semi-custom educational and developmental design system that is easy to use, that can be used through the internet, in a store or from a remote location, and enables the consumer to design and redesign a semi-custom educational and developmental program for an Individual at an affordable cost.

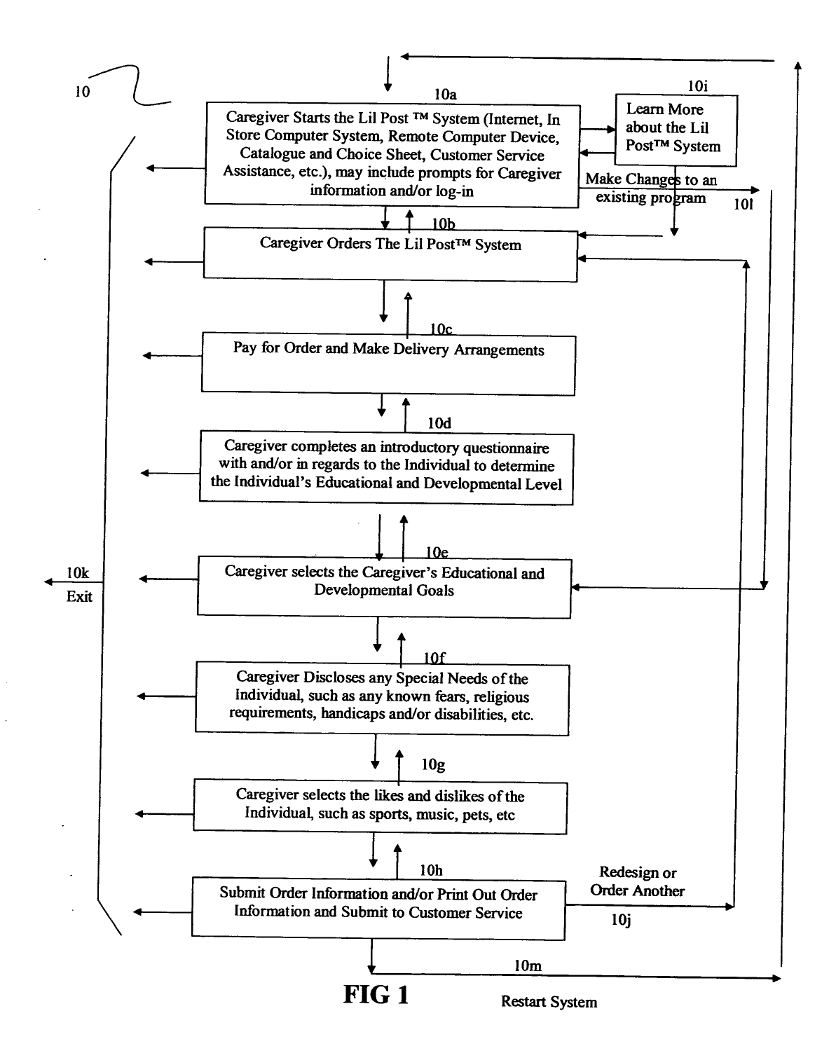

Referring first to FIG. 1, the User Side of the Lil Post™ System of the present invention is generally indicated by the reference numeral 10, and comprises the steps of: 1) Initiating the Lil Post™ System, generally indicated by reference numeral 10a; 2) Ordering the Lil Post™ System, generally indicated by reference numeral 10b; 3) Making Payment and Delivery Arrangements, generally indicated by reference numeral 10c; 4) Completing an Introductory Questionnaire, generally indicated by reference numeral 10d, wherein the Lil Post™ System automatically calculates the Individual's Educational and Developmental Level; 5) Selecting the Caregiver's Educational and Developmental Goals, generally indicated by reference numeral 10e; 6) Disclosing the Special Needs of the Individual, generally indicated by reference numeral 10f; 7) Selecting the Likes and Dislikes of the Individual, generally indicated by reference numeral log; 8) Order Submission Step, generally indicated by reference numeral 10h; 9) Learning More about the Lil Post™ System, generally indicated by reference numeral 10i; 10) Making Changes to the Caregiver's Educational and Developmental Goals, the Special Needs of the Individual, or the Likes and Dislikes of the Individual or Ordering another Program, generally indicated by reference numeral 10j; 11) Exiting the Lil Post™ System, which may be also aborted at any time during the process, generally indicated by reference numeral 10k; 12) Changing an existing program, generally indicated by reference numeral 10l; and 13) Restarting the Lil Post™ System Step, generally indicated by reference numeral 10m.

FIG. 1 is submitted to illustrate the general flow of the Lil Post™ system. The Lil Post™ System illustrated in FIG. 1, however, is not limited to executing the steps in the order given. For example, the Caregiver may move sequentially backward and forward between the previous and the next screen via previous and next option keys, which are illustrated by up and down arrows in FIG. 1. Furthermore, the Caregiver's and Individual's information such as name and address and payment information may be input at the end of the process rather than the beginning; a Caregiver logon or identification card may be required prior to initiating the system or prior to ordering the Lil Post™ System; the Caregiver may restart the program where they left off in their previous session; or provide payment information that was not available during the previous session. All methods of executing the Lil Post™ system known to those skilled in the art are contemplated for said invention.

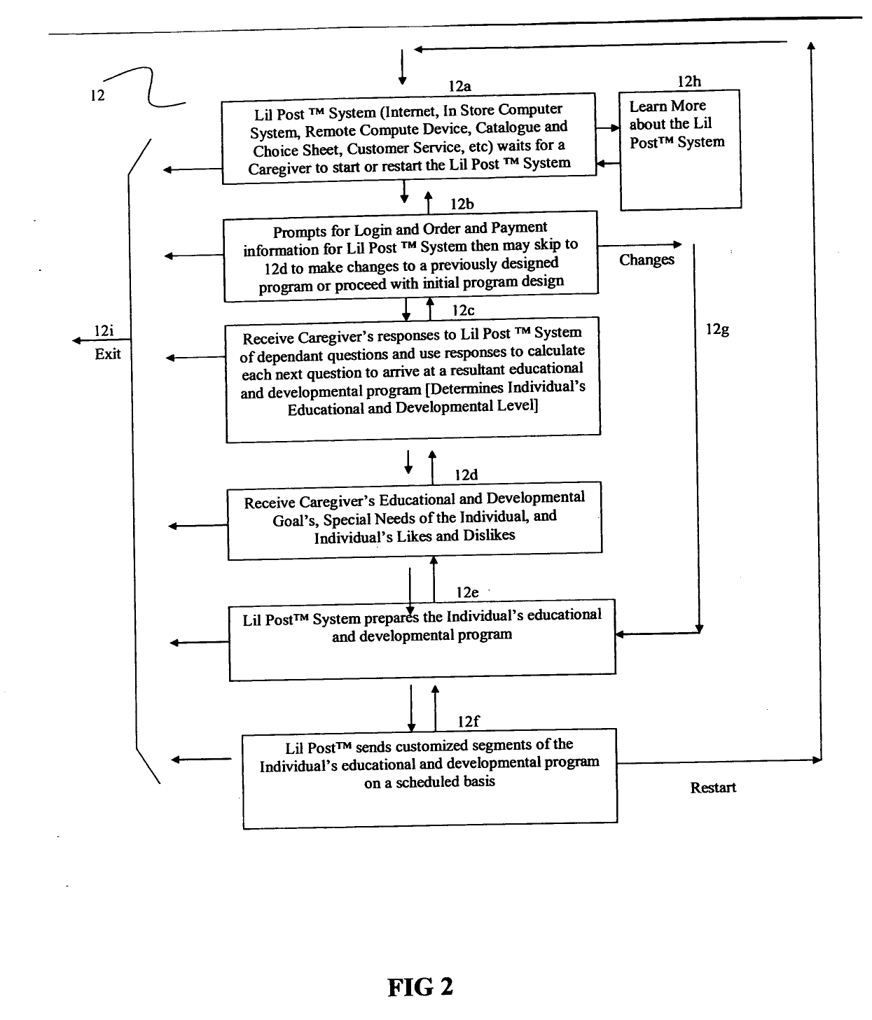

Referring first to FIG. 2, the System Side of the Lil Post™ System of the present invention is generally indicated by the reference numeral 12, and comprises the steps of: 1) Waiting for input from the user, generally indicated by reference numeral 12a; 2) Receiving and Processing Order and Payment Information, generally indicated by reference numeral 12b; 3) Displaying and receiving input relating to a series of selective dependant questions which determine the Individual's Educational and Developmental Level, generally indicated by reference numeral 12c; 4) Displaying and Receiving input as to the Caregiver's Goals and the Individuals special needs and or likes or dislikes, generally indicated by reference numeral 12d, 5) Preparing the customized Lil Post™ program, generally indicated by reference numeral 12e; 6) Delivering the customized Lil Post™ program to the Individual on a scheduled basis, generally indicated by reference numeral 12f; 7) Making Changes to the customized program, generally indicated by reference numeral 12g; 8) Restarting, or 9) Exiting the System, which may be also aborted any time during the process, generally indicated by reference numeral 12i.

FIG. 2 is submitted to illustrate the general flow of the Lil Post™ system from the system perspective. The Lil Post™ System illustrated in FIG. 2, however, is not limited to executing the steps in the order given. For example, the system may jump backward and forward between steps, which is indicated by up and down arrows in FIG. 2. Furthermore, the system may request the Caregiver's and Individual's information such as name and address and payment information later in the program rather than the beginning; a Caregiver logon or identification card may be required prior to initiating the system or prior to ordering the Lil Post™ System; the system may restart where it was left off; or accept payment information that was not available during the previous session. All methods of executing the Lil Post™ system known to those skilled in the art are contemplated for said invention. The system may utilize data storage and retrieval methods such as computer systems and manual methods, or those known to one skilled in the art.

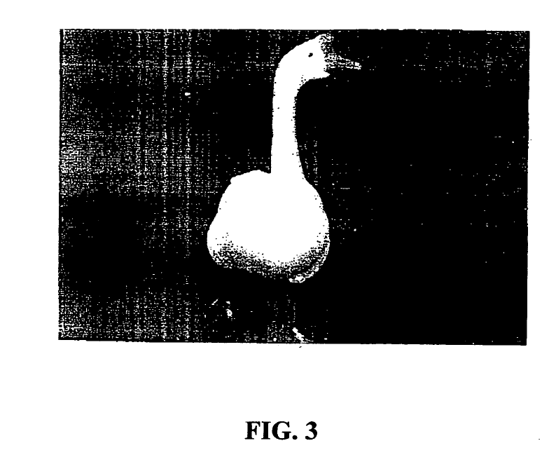

Now turning to FIG. 2 and FIG. 3, an embodiment of a first portion of an educational and developmental tool of the Lil Post™ system of the present invention is generally indicated by reference numeral 12. An embodiment of a second portion of an educational and developmental tool of the Lil Post™ system of the present invention is generally indicated by reference numeral 13, wherein said second portion 13 is to be used as a guide, preferably by the Caretaker, but may be used by the Individual, to point out developmental and educational areas of said first portion 12. Each educational and developmental tool of the Lil Post™ Program is designed according to the Individual's Level, the Caregiver's Educational and Developmental Goals, the Individual's Special Needs and the Individuals Likes or Dislikes, as well as other criteria that may be considered. All educational and developmental modes are contemplated, including, but not limited to, picture montages, tactile surfaces, audibles, puzzles, pictures, photographs, collages, kits, etc.

In practice, the User Side of the Lil Post™ system comprises: 1) Executing the steps as shown in FIG. 1 and described above; 2) Receiving educational and developmental tools through a Mail Service; 3) Educating and Developing the Individual by having the Caretaker review the educational and developmental tools with the Individual; and 4) Optionally repeating steps 1 through 3.

In practice, the System Side of the Lil Post™ system comprises: 1) Receiving Data from the Caregiver; 2) Calculating the Individual's Educational and Developmental Level based on the Caregiver's Questionnaire; 3) Receiving Data from the Caregiver regarding the Caregiver's Educational and Developmental Goals; 4) Receiving Data from the Caregiver regarding the Special Needs of the Individual; 5) Receiving Data from the Caregiver regarding the Likes and Dislikes of the Individual; 6) Compiling the Data to customize an educational and developmental program for the Individual; 7) Sending said customized educational and developmental tools through a Mail Service; 8) Educating and Developing the Individual by having the Caretaker review the educational and developmental tools with the Individual; and 9) Optionally repeating steps 1 through 8.

All methods of executing the Lil Post™ system known to those skilled in the art are contemplated for said invention including virtual stores, real stores, catalogue, etc. The system may utilize data storage and retrieval methods such as computer systems and manual methods, or those known to one skilled in the art.

It will be apparent to those skilled in the art that the method of the present invention can be implemented in a variety of ways, either at the store location or remotely. For example, in one embodiment, a manual system might use a card file or catalogue, together with an instruction manual or ordering sheet to go through the logic illustrated in FIG. 1. Alternatively, in other embodiments, an electronic device, such as a dedicated palmtop device similar to a pre-programmed electronic calculator could be used. Either of these might be used in conjunction with a fax machine or a modem to convey the program information to a central information processing and distribution system. Additionally, a voice-activated system or device or interactive touch screen could be connected to a computer system to implement the invention. Furthermore a Personal Data Assistant (PDA), Computer or other Internet connecting device could be used to utilize the Lil Post™ system. The Lil Post™ system may include other means of communication and data transfer when they become available as technology advances.

Having disclosed at least one embodiment of the present invention, various adaptations, modifications, additions, and improvements will be readily apparent to those of ordinary skill in the art. Such adaptations, modifications, additions and improvements are considered part of the invention which is only limited by the several claims attached hereto.

1. A method for providing customized training segments for an individual, the method comprising the steps of:
receiving information relating to the individual's development level;
receiving information relating to the individual's characteristics;
developing a training program; and
creating training segments corresponding to portions of the training program.

2. The method for providing customized training segments for an individual according to claim 1, wherein the step of receiving information relating to the individuals development level includes the steps of:
providing a first set of questions;
receiving responses to the first set of questions;
providing a second set of questions wherein the second set of questions depends upon the responses to the first set of questions.

3. The method for providing customized training segments for an individual according to claim 1, wherein the information relating to the individual's development level is received from a caregiver for the individual.

4. The method for providing customized training segments for an individual according to claim 1, wherein the individual's characteristics include at least one of:
a development goal for the individual;
a special need of the individual; and
a preference of the individual.

5. The method for providing customized training segments for an individual according to claim 1, further comprising, prior to the first receiving step, the steps of:
requesting identification information from a user;
receiving identification information from a user; and
verifying the identity of the user.

6. The method for providing customized training segments for an individual according to claim 1, wherein the receiving steps include receiving information from a computer network.

7. The method for providing customized training segments for an individual according to claim 1, further comprising the step of transmitting the training segments to the individual.

8. The method for providing customized training segments for an individual according to claim 1, wherein the transmitting step includes transmitting the training segments to a computer network.

9. The method for providing customized training segments for an individual according to claim 8, wherein the transmitting step includes mailing training segments.

10. A system for providing customized training segments for an individual comprising:
means for receiving development information relating to the individual's development level;
means for receiving characteristic information relating to the individual's characteristics;
a memory for storing training information relating to training programs;
means for selecting from the memory training information based upon the development information and the characteristic information to create a training program; and
means for selecting from the memory training segment information based upon the training program.

11. The system for providing customized training segments for an individual according to claim 10, wherein the means for receiving development information includes:
means for receiving a first set of development information;
means for generating a set of questions based upon the first set of development information; and
means for receiving a second set of development information in response to the set of questions.

12. The system for providing customized training segments for an individual according to claim 1, wherein the information relating to the individual's development level is received from a caregiver for the individual.

13. The system for providing customized training segments for an individual according to claim 1, wherein the individual's characteristics include at least one of:
a development goal for the individual;
a special need of the individual; and
a preference of the individual.

14. The system for providing customized training segments for an individual according to claim 1, further comprising:
identification means for identifying a user of the system.

15. The system for providing customized training segments for an individual according to claim 1, further comprising a printer for printing the selected training segment information.
